(19) United States
(12) Patent Application Publication
(10) Pub. No.: US 2025/0086860 A1
(43) Pub. Date: Mar. 13, 2025

(54) KNOWLEDGE EDIT IN A TEXT-TO-IMAGE MODEL

(71) Applicant: Adobe Inc., San Jose, CA (US)

(72) Inventors: Varun Manjunatha, Riverdale, MD (US); Vlad Ion Morariu, Potomac, MD (US); Samyadeep Basu, College Park, MD (US); Nanxuan Zhao, San Jose, CA (US)

(73) Assignee: Adobe Inc., San Jose, CA (US)

(21) Appl. No.: 18/425,335

(22) Filed: Jan. 29, 2024

Related U.S. Application Data
(60) Provisional application No. 63/581,974, filed on Sep. 11, 2023.

(51) Int. Cl. G06T 11/60; G06N 20/00

(52) U.S. Cl. CPC G06T 11/60; G06N 20/00; G06T 2200/24

(57) ABSTRACT

Knowledge edit techniques for text-to-image models and other generative machine learning models are described. In an example, a location is identified within a text-to-image model by a model edit system. The location is configured to influence generation of a visual attribute by a text-to-image model as part of a digital image. An edited text-to-image model is formed by editing the text-to-image model based on the location. The edit causes a change to the visual attribute in generating a subsequent digital image by the edited text-to-image model. The subsequent digital image is generated as having the change to the visual attribute by the edited text-to-image model.

### RELATED APPLICATIONS

This application claim priority under 35 U.S.C. § 119(e) to U.S. Provisional Patent Application No. 63/581,974, filed Sep. 11, 2023, Attorney Docket No. P12625-US, and titled “Knowledge Edit in a Text-to-Image Model,” the entire disclosure of which is hereby incorporated by reference.

### BACKGROUND

Functionality available via machine-learning models continues to expand, from initial error correction and object recognition techniques to generative techniques usable to generate text, digital images, and so forth. In order to support this expanded functionality, an amount of training data used train the machine-learning models also continues to expand. In some instances, this expansion involves use of over a billion items of training data.

Accordingly, technical challenges arise in gaining insight into which items of training data are used as part of the training as well as an effect on functionality of machine-learning model the use of these items of training data have in performing a desired operation.

### SUMMARY

Knowledge edit techniques for text-to-image models and other generative machine learning models are described. In an example, a location is identified within a text-to-image model by a model edit system. Identification of the location is configured to influence generation of the visual attribute by a text-to-image model as part of a digital image. To do so in one or more examples, causal mediation analysis is performed.

An edited text-to-image model is generated using the model edit system by editing the text-to-image model based on the location. The edit causes a change to the visual attribute in generating a subsequent digital image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ knowledge location and edit techniques for machine-learning models as described herein.

FIG. 2 depicts a system showing operation of a model edit system in greater detail as finding a location within a text-to-image model associated with a visual attribute and editing the location.

FIG. 3 depicts an example implementation of a user interface configured to receive a visual attribute input.

FIG. 4 depict an example implementation of a verification user interface.

FIG. 5 depicts an implementation showing configuration of an example architecture of the symmetric encoder-decoder machine-learning model in greater detail.

FIG. 6 depicts a system in an example implementation showing operation of an encoder-decoder knowledge tracking module by a causal mediation analysis module in greater detail.

FIG. 7 depicts a system in an example implementation showing operation of a text-encoder knowledge tracing module by the causal mediation analysis module in greater detail.

FIG. 8 depicts a system in an example implementation showing operation of the concept editing module of the model edit system in greater detail in editing a text encoder machine-learning model.

FIG. 9 is a flow diagram depicting an algorithm as a step-by-step procedure in an example implementation of operations performable for accomplishing a result of forming an edited text-to-image model based on a location identified as corresponding to a visual attribute in the text-to-image model.

FIG. 10 is a flow diagram depicting an algorithm as a step-by-step procedure in an example implementation of operations performable for accomplishing a result of forming an edited text-to-image model based on an uncorrupted machine learning model, a corrupted machine learning model, and a restored machine learning model.

FIG. 11 is a flow diagram depicting an algorithm as a step-by-step procedure in an example implementation of operations performable for accomplishing a result of forming an edited text-to-image model by editing a text to image mode based on a location configured to influence generation of a visual attribute.

FIG. 12 illustrates an example system including various components of an example device that can be implemented as any type of computing device as described and/or utilize with reference to. 1-11 to implement embodiments of the techniques described herein.

### DETAILED DESCRIPTION

### Overview

Machine-learning models continue to expand an amount of functionality made available by the models. Examples of this functionality include error correction, natural language processing and image analysis and have expanded to generative techniques usable to generate text, digital images, and so forth. A text-to-image model, for instance, is configured to generate a digital image based on a text input. Training of the text-to-image model, however, typically involves a multitude of items of training data (e.g., digital images and captions) that may well number into the billions. Consequently, training of the text-to-image model using this multitude of items of training data introduces numerous technical challenges. These technical challenges are often caused due to a lack of insight into individual items being used in the training and corresponding functionality made possible through use of these items.

Concerns have been raised in real world implementations, for instance, with respect to legality of a text-to-image model to render trademarked objects, copyrighted artistic styles, and so forth. Additional concerns involve generation of inappropriate or insensitive content, illegal content, generation of stale digital images, and so forth. Concerns involving stale data, for instance, involve generation of content that is out-of-date, e.g., generation of a digital image for a past president instead of a current president.

Conventional techniques used to address these concerns involve expensive retraining of the text-to-image model on a training dataset that does not include these concerns, which may still involve a multitude of training data. Even then, due to generative nature of the text-to-image model it is difficult if not impossible in conventional techniques to adequately protect against these potential issues due to the limited insight provided by text-to-image model in determining how these digital images are created, i.e., “what” prompted generation of digital content exhibiting a potential issue.

To address these and other technical challenges, knowledge edit techniques in a text-to-image model are described, which are also applicable to other generative machine-learning models. The knowledge edit techniques support an ability to understand how knowledge is stored within a text-to-image model and then use this information to edit the model, e.g., to protect against the issues described above. In real-world examples, these techniques support increased computational efficiency that is over a thousand times faster than conventional techniques, e.g., these techniques may be performed in less than a second to update or remove concepts from a given generative machine-learning model.

In one or more examples involving a text-to-image model, the model is trained using a multitude of items of training data (e.g., digital image/caption combinations) to generate digital images based on input text, solely. The text-to-image model is received as an input by a model edit system. The model edit system is configured to output a user interface, via which, a visual attribute input is received to specify a visual attribute of interest, e.g., to be changed or updated. The visual attribute, for example, is configurable to specify an object, style, color, viewpoint, action, concept and so on. Other non-visual attributes are also contemplated, e.g., in support of text generation.

The model edit system is then tasked with finding a location within the text-to-image model that supports an ability of the text-to-image model to generate the visual attribute. To do so, causal mediation analysis is performed by the model edit system to analyze a causal inference through change in a response variable of the visual attribute based on an intervention on intermediate variables of interest of the text-to-image model, i.e., what casual influences generate of the response variable.

The model edit system, for instance, receives the text-to-image model as an uncorrupted machine-learning model. The model edit system then generates a corrupted machine-learning model based on the text-to-image model. For example, the model edit system corrupts the text-to-image model by introducing Gaussian noise to a symmetric encoder-decoder machine-learning model or text encoder machine-learning model of the text-to-image model.

The model edit system then generates a restored machine-learning model based on the corrupted machine-learning model. The model edit system, for instance, applies activations from one or more nodes in one or more layers from the text-to-image model (i.e., as an uncorrupted machine-learning model) to the corrupted machine-learning model to form the restored machine-learning model.

The restored machine-learning model is then used to generate a candidate digital image, e.g., based on the visual attribute. The candidate digital image is compared by the model edit system to a digital image generated by the text-to-image model based on the visual attribute. If the candidate digital image includes the visual attribute based on the comparison, then the location within the text-to-image model that corresponds to the visual attribute is located, e.g., through the one or more nodes from the one or more layers from which the activations are copied. The model edit system then outputs a model location indication indicating the found location that is a basis for the knowledge used to generate the visual attribute, which is then usable to edit the text-to-image model.

The model edit system, for example, is configurable to employ techniques to ablate or update concepts supported by the text-to-image model in a closed form. As previously described, these techniques support increased efficiency that is over a thousand times faster than conventional fine-tuning based approaches. In an edit example involving a text encoder machine-learning model of the text-to-image model, weighted matrixes are located from a self-attentional layer. A projection weight matrix is then identified and the location is updated using caption pairs (k.v) in which “k” (i.e., key) is an original caption and a value “v” is a caption, to which, the key “k” is to be mapped. For example, to remove a style of Van Gogh the key “k” is set as “style of Van Gogh” and the value “v” is set as “style of generic watercolor.”

In this way, the model edit system is configured to both find a location corresponding to a visual attribute (or other attribute) in a text-to-image model and edit the text-to-image model, such as to ablate the visual attribute (e.g., to remove an ability to generate a trademarked image), update the visual attribute (e.g., to reflect a current president), and so on. Although the following discussion describes use of a text-to-image model, these techniques are also applicable to other generative machine-learning models, e.g., text generation, conversational artificial intelligence, language models, and so forth.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Machine Learning Knowledge Edit Environment

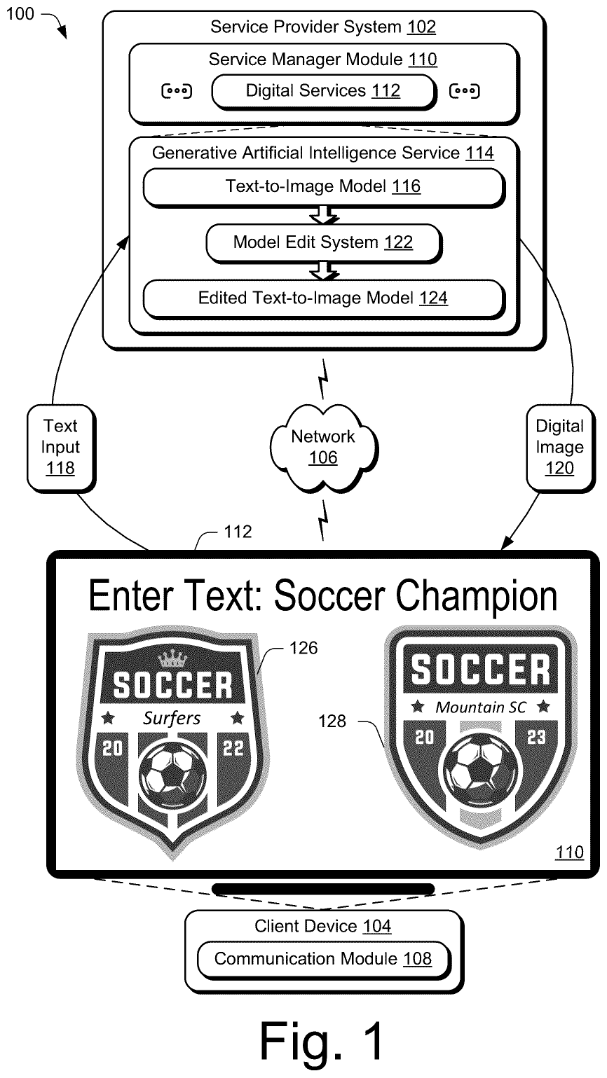

FIG. 1 is an illustration of a digital medium environment 100 in an example implementation that is operable to employ knowledge location and edit techniques for machine-learning models as described herein. The illustrated environment 100 includes a service provider system 102 and a client device 104 that are communicatively coupled, one to another, via a network 106. Computing devices that implement the service provider system 102 and the client device 104 are configurable in a variety of ways.

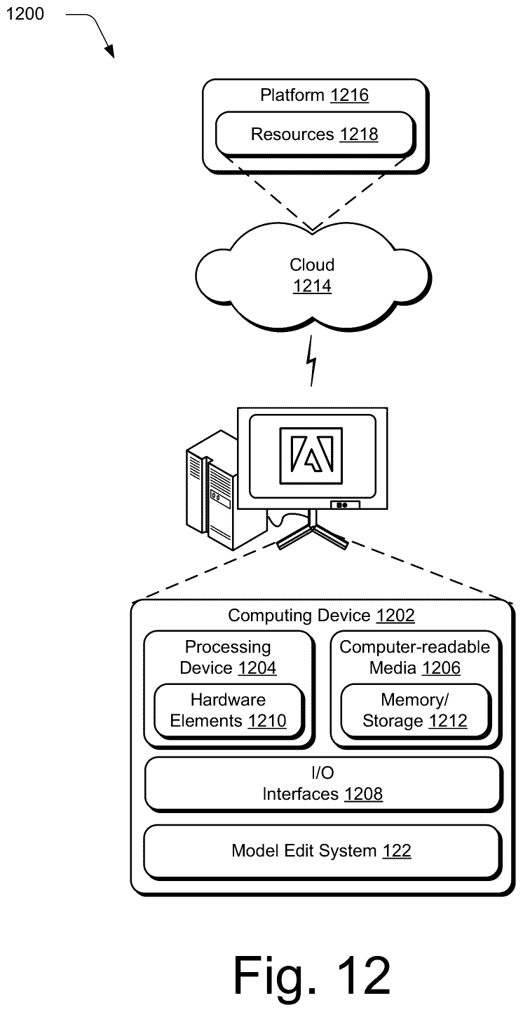

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is described in some examples, a computing device is also representative of a plurality of different devices, such as multiple servers utilized by a business to perform operations “over the cloud” as described in FIG. 12.

The client device 104 includes a communication module 108 that is representative of functionality to communicate via the network 106 with a service manager module 110 of the service provider system 102. The service manager module 110 is configured to implement digital services 112. Digital services 112 are usable to expose a variety of functionality to the client device 104, an example of which is illustrated as a generative artificial intelligence service 114. The generative artificial intelligence service 114 is configured to create new digital content based on received inputs. The generative artificial intelligence service 114, for instance, is configurable to generate text, digital images, computer programs, digital music, and so forth.

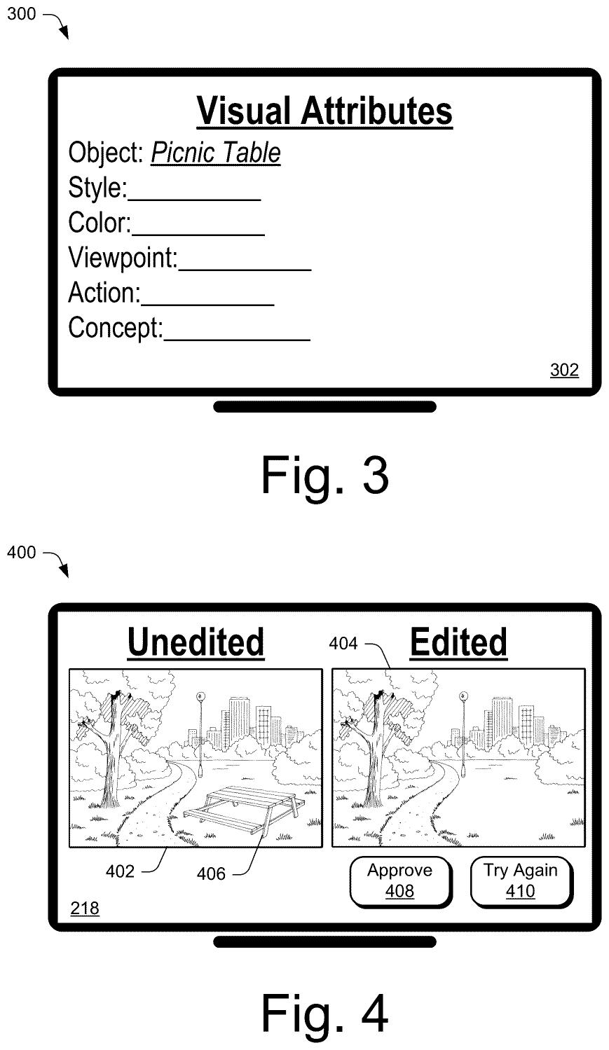

In the illustrated example, the generative artificial intelligence service 114 employs a text-to-image model 116. The text-to-image model 116 is configured to receive a text input 118 (e.g., having text, solely) and from this input generate a digital image 120. The text-to-image model 116 is configurable in a variety of ways, examples of which include a generative adversarial network (GAN), use of a diffusion model, and so forth. Diffusion models, as further described in relation to FIG. 3, are trained to transform a simple initial distribution into a complex distribution by applying a series of reversible transformations to implement the diffusion process in order to generate an output, e.g., the digital image 120.

As previously described, conventional generative machine learning techniques are confronted with numerous concerns. Examples of these concerns include generation of inappropriate or insensitive content, illegal content, trademarked or copyrighted content, generation of stale digital images having outdated objects, and so forth.

Conventional techniques used to address these technical challenges involve expensive retraining of the text-to-image model on a training dataset that does not include these concerns, which may still involve a multitude of training data. Further, due to generative nature of the text-to-image model it is difficult if not impossible in conventional techniques to adequately protect against these potential issues due to the limited insight provided by text-to-image model in determining how these digital images are created, i.e., “what” prompted generation of digital content exhibiting a potential issue.

Central to concerns and techniques used to address these concerns is that text-to-image models, similar to other deep learning models, are expensive to train and retrain. Accordingly, behavioral corrections to the deep learning models (e.g., negating an ability to generate trademarked objects or copyrighted artistic styles, updating knowledge, restricting outputs to child-friendly images, and so on) in conventional techniques involves an expensive re-training effort on a dataset that does not include items of training data having the behavior to be corrected.

To address these and other technical issues and concerns, a model edit system 122 is implemented to edit an underlying structure of the text-to-image model 116 to form an edited text-to-image model 124 that addresses these concerns. The model edit system 122 is configured to generate the edited text-to-image model 124 such that the edited model is incapable of generating the digital image 120 to include the visual attribute in an ablation example, updates the visual attribute and is incapable of generating an out-of-date visual attribute, and so forth.

In the illustrated example, the model edit system 122 is configured to update the text-to-image model 116 from a stale digital image 126 to an updated digital image 128 to accurately reflect generation of a digital image 120 for a “current soccer champion” text input 118. In this way, the model edit system 122 differs from conventional techniques that rely on filtering of inputs (e.g., for offensive information, trademarks, etc.) that may be defeated using alternate wordings, e.g., filtering of a name of a cartoon character that is defeated by describing behaviors and situations associated with that cartoon character such as “the lizard from the commercial.”

In one or more implementations, the model edit system 122 is configured to implement several types of post-training behavioral corrections such as concept ablation, knowledge updates, and so on in under one second on a single graphics processing unit (GPU). Concretely, the input to the model edit system 122 is the text-to-image model 116 and a visual attribute input involving a model behavior to be edited, e.g., remove an ability to generate a digital image having a particular trademark. The output of the model edit system 122 is an edited text-to-image model 124 that does not have the ability render the trademark in question, while keeping other generative abilities intact.

The model edit system 122 is configurable to perform multiple edits to the text-to-image model 116 in succession. The model edit system 122, for instance, generates the edited text-to-image model 124 to remove an ability to render multiple trademarked objects while also updating a world-knowledge update, e.g., a current president. In a commercial scenario, this functionality supports improved protection to parties and is agile to customer or public feedback in order to promptly respond to edit requests. In this way, the model edit system 122 avoids inefficiencies of conventional techniques involved in retraining and fine-tuning a machine learning model by identifying a precise location associated with a particular behavior (e.g., a visual attribute), an example of which is further described as implementing Causal Mediation Analysis. The model edit system 122 also supports use of a sub-second closed-form optimization to edit weights of the machine learning model associated with that location, which results in generation of an edited machine-learning model having an updated behavior. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Knowledge Edit for a Generative Machine Learning Model

The following discussion describes knowledge edit techniques for generative machine learning models that are implementable utilizing the described systems and devices and performable without retraining of the model. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

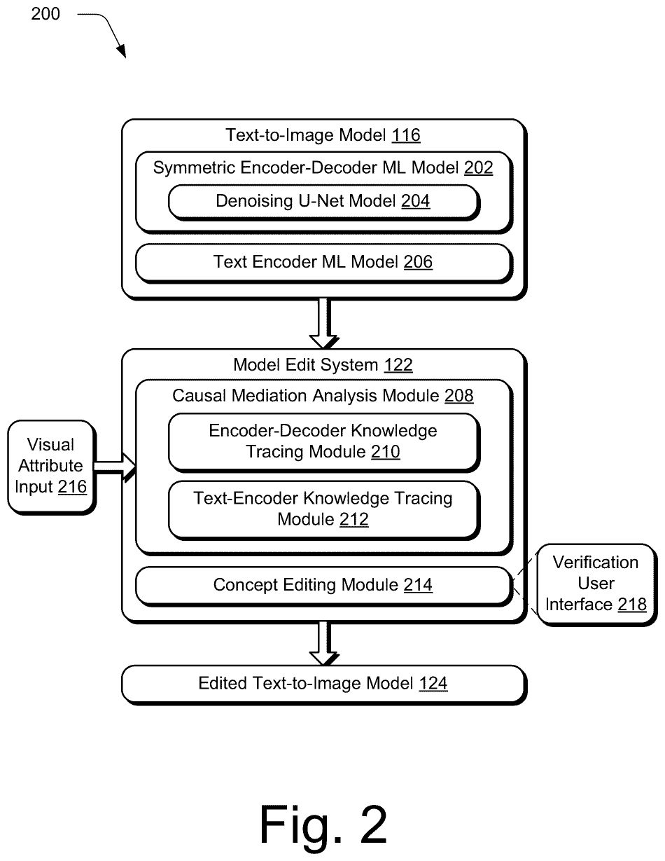

FIG. 2 depicts a system 200 showing operation of a model edit system 122 in greater detail as finding a location within a text-to-image model associated with a visual attribute and editing the location. The text-to-image model 116 is implemented in this example using a symmetric encoder-decoder machine learning model, illustrated as symmetric encoder-decoder ML model 202. The symmetric encoder-decoder ML model 202, for instance, is configurable in a variety of ways, an illustrated example of which is illustrated as a denoising U-Net model 204. The text encoder ML model 206 is configurable in a variety of ways, an example of which is a CLIP-ViT-L/336px text encoder. Examples of both the denoising U-Net model 204 and the CLIP-ViT-L/336px text encoder are incorporated by reference in their entirety as described by Robin Rombach, Andreas Blattmann, Dominik Lorenz, Patrick Esser, and Bjorn Ommer, High-resolution Image Synthesis with Latent Diffusion Models. CoRR, abs/2112.10752, 2021.

The model edit system 122 is illustrated as implementing a causal mediation analysis module 208. The casual mediation analysis module 208 implements techniques for causal interference by analyzing a change in a response variable following an intervention on one or more intermediate variables of interest, also called “mediators.”

The causal mediation analysis module 208, for instance, is usable to address internal model components (e.g., specific neurons or layers) of the text-to-image model 116 as mediators along a directed acyclic graph between an input and output. For text-to-image model 116, causal mediation analysis is usable to trace causal effects of these internal model components within the symmetric encoder-decoder ML model 202 and the text encoder ML model 206 that are employed in generation of digital images having respective visual attributes.

For example, the causal mediation analysis module 208 is usable to employ an encoder-decoder knowledge tracking module 210 to identify causal components in the symmetric encoder-decoder ML model 202 and a text-encoder knowledge tracing module 212 to identify causal components in the text encoder ML model 206. The encoder-decoder knowledge tracking module 210, for instance, is configurable to identify causal model components at a granularity of nodes and/or layers that include the nodes. For the text-encoder knowledge tracing module 212, causal tracing is performable for the text encoder ML model 206 at a granularity of hidden states of token embeddings in “c” distinct layers.

Accordingly, the causal mediation analysis module 208 is configured to localize knowledge within the text-to-image model 116 to specific nodes and/or layers. The localized knowledge of the causal mediation analysis module 208 is then usable by a concept editing module 214 to edit the specific nodes and/or layers of the text-to-image model 116 to form the edited text-to-image model 124.

The model edit system 122, in the illustrated example, receives a visual attribute input 216 identifying a visual attribute. FIG. 3 depicts an example implementation 300 of a user interface 302 configured to receive a visual attribute input 216. The visual attribute input 216 may take a variety of forms, illustrated examples of which include an object, a style, a color, a viewpoint, an action, a concept, and so on. Accordingly, the user interface 302 is configured to identify the visual attribute that is a subject of an edit to the machine-learning model, e.g., for ablation, update, and so forth.

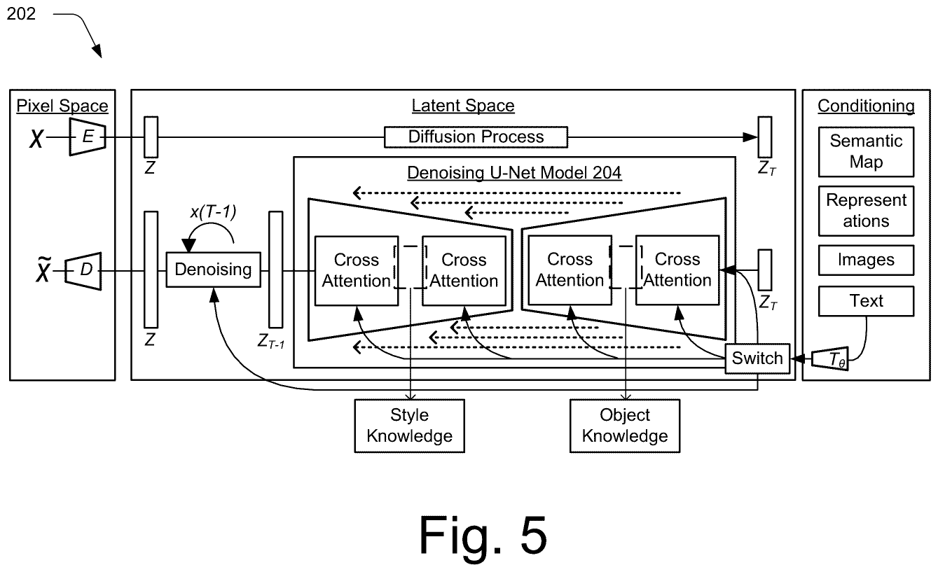

Returning again to FIG. 2, the causal mediation analysis module 208 is then used to locate a corresponding location in the text-to-image model 116, e.g., using the encoder-decoder knowledge tracking module 210 and/or the text-encoder knowledge tracing module 212 as described above. A model location indication is then output from the causal mediation analysis module 208 to a concept editing module 214. The model location indication, for instance, identifies nodes and/or layers of the text-to-image model 116 that are associated with generation of the visual attribute. The concept editing module 214 is then usable to edit the identified location within the text-to-image model 116 for generate the edited text-to-image model 124. In one or more implementations, a verification user interface 218 is output to verify that the model edit system 122 achieved a desired result and/or cause the model edit system 122 to continue use of the causal mediation analysis module 208 and the concept editing module 214 over additional iterations to achieve a desired result as further described in relation to FIG. 4.

The denoising U-Net model 204, for instance, is formable using seventy distinct layers distributed amongst three types of blocks, e.g., (i) down-block, (ii) midblock, and (iii) up-block. Each of these blocks contain a varying number of cross-attention layers, self-attention layers and residual layers. For the text-encoder ML model 206 “v_{γ},” there are twelve blocks in total with each block including a self-attention layer and a multilayer perceptron (MLP) layer. Given a caption “c” (e.g., as an example of text input 118) in one or more instances, a denoising U-Net model 204 generates a digital image 120 “x” starting with random Gaussian noise. The digital image 120 “x” encapsulates the visual attributes embedded in the caption “c.” For example, the caption “c” can contain visual attributes corresponding to objects, style, color, viewpoint, action, concept, and so forth.

FIG. 5 depicts an implementation showing configuration of an example architecture of the symmetric encoder-decoder ML model 202 in greater detail. Diffusion models are implemented to learn to denoise data through a number of iterations. In an example, noise is added to the data following a Markov chain across multiple time-steps “t∈[0, T].” Starting from an initial random real image “x₀,” the noisy image at time-step “t” is defined as “xₜ=\sqrt{aₜ}x₀+\sqrt{(1−aₜ)}ϵ.” In the above expression, the variable “αₜ” defines a strength of random Gaussian noise applied that gradually decreases as the time-step increases such that “x_{T}˜ [symbol] (0, I).” The denoising network denoted by “ϵ_{θ}(xₜ, c, t)” is pre-trained to denoise a noisy image “xₜ” to obtain “xₜ₋₁”.

In one or more examples, the conditional input “c” to the denoising network “ϵθ(.)” is a text-embedding of a caption “c” through a text-encoder “c=v_{γ}(c)” which is paired with an original digital image “x₀.” The pre-training objective for diffusion models may be defined as follows for a given image-text pair denoted by “(x, c)”:

$$( x , c ) = {ϵ , t}_{} {‖ ϵ - {ϵ}_{θ} ( {x}_{t} , c , t ) ‖}_{2}^{2} ,$$

where “θ” is a set of learnable parameters. For increased training efficiency, the noising operation as well as the denoising operation may be performed in a latent space defined by “z=ε(x).” In this case, the pre-training objective learns to denoise in the latent space as denoted by:

$$( x , c ) = {ϵ , t}_{} {‖ ϵ - {ϵ}_{θ} ( {z}_{t} , c , t ) ‖}_{2}^{2}$$

where “zₜ=ε(xₜ)” and “E” is an encoder. During inference, where the objective is to synthesize an image given a text-condition “c,” a random Gaussian noise “x_{T}˜ [symbol] (0, I)” is iteratively denoised over a fixed range of time-steps in order to produce the final image.

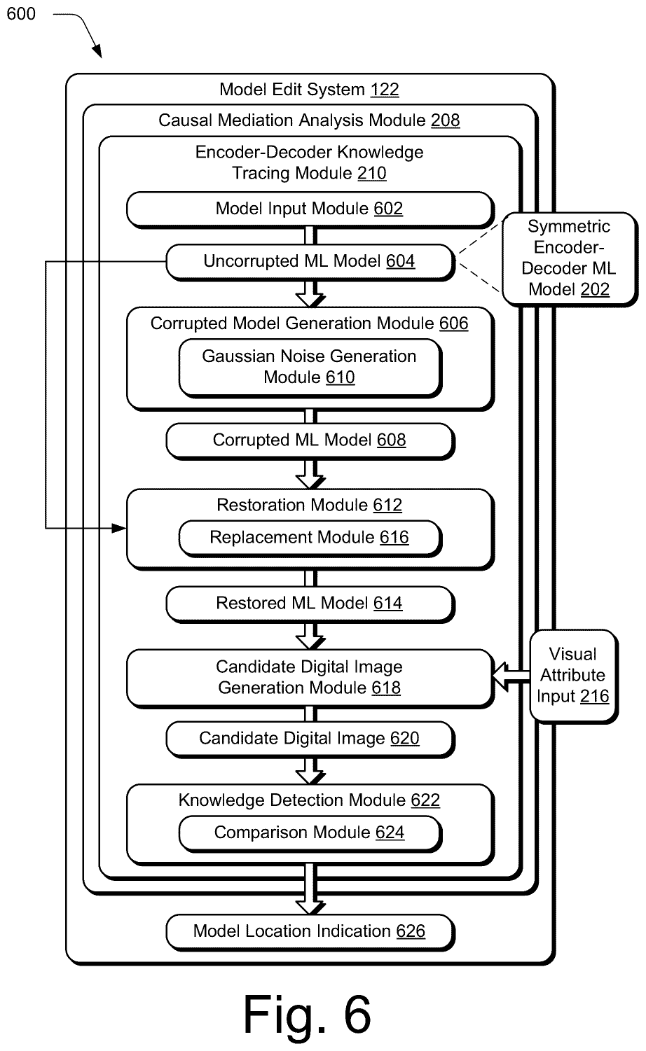

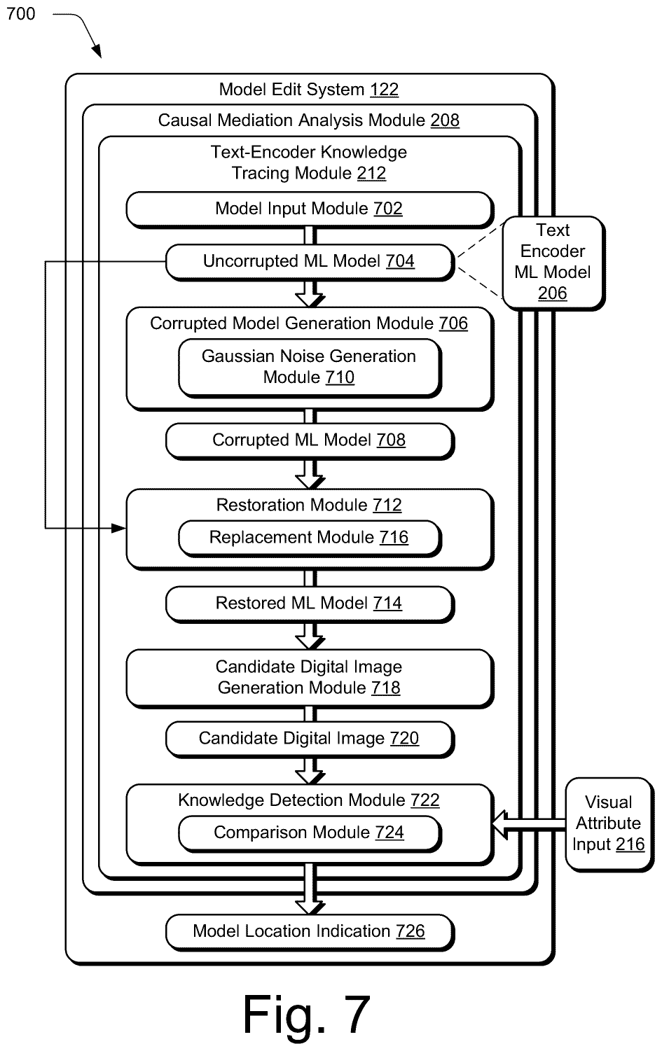

FIG. 6 depicts a system 600 in an example implementation showing operation of the encoder-decoder knowledge tracking module 210 by the causal mediation analysis module 208 in greater detail. To begin in this example, the model input module 602 receives an uncorrupted machine learning model, depicted as uncorrupted ML model 604. The uncorrupted ML model 604, for instance, is configurable as a symmetric encoder-decoder ML model 202 from the text-to-image model 116 that is unchanged.

The model input module 602 is then passed to a corrupted model generation module 606 to generate a corrupted machine learning model (illustrated as corrupted ML model 608) from the uncorrupted ML model 604. To do so, the corrupted model generation module 606 employs a Gaussian noise generation module 610 to corrupt the uncorrupted ML model 604 with Gaussian noise, e.g., by applying noise to activations of nodes of the uncorrupted ML model 604.

A restoration module 612 is then utilized in this example to generate a restored machine learning model (illustrated as restored ML model 614) from the corrupted ML model 608. As part of this, a replacement module 616 is utilized to replace activations at one or more nodes and/or one or more layers of the corrupted ML model 608 with activations from the uncorrupted ML model 604. The replacement module 616, for instance, selects a layer within the uncorrupted ML model 604 and passes activations from that layer as replacing activations at a corresponding layer of the corrupted ML model 608, thereby forming the restored ML model 614.

The restored ML model 614 is then passed to a candidate digital image generation module 618 to generate a candidate digital image 620. The candidate digital image generation module 618, for instance, utilizes a text input (e.g., the visual attribute input 216) corresponding to the visual attribute in question and from this generates the candidate digital image 620.

A knowledge detection module 622 is then utilized by the encoder-decoder knowledge tracking module 210 to compare the candidate digital image 620 with a digital image generated by the uncorrupted ML model 604, i.e., the symmetric encoder-decoder ML model 202 in this example. The comparison is utilized to detect a similarity of the candidate digital image 620 with the digital image generated by the uncorrupted ML model 604, and therefore whether the replaced activations from the nodes and/or layers of the uncorrupted ML model 604 caused the change. The comparison module 624 is configurable to perform the comparison in a variety of ways, examples of which include scoring techniques to measure visual similarity such as Cosine similarity which is a use of a indirect estimation effect as part of a causality determination, perceptual similarity, and so forth.

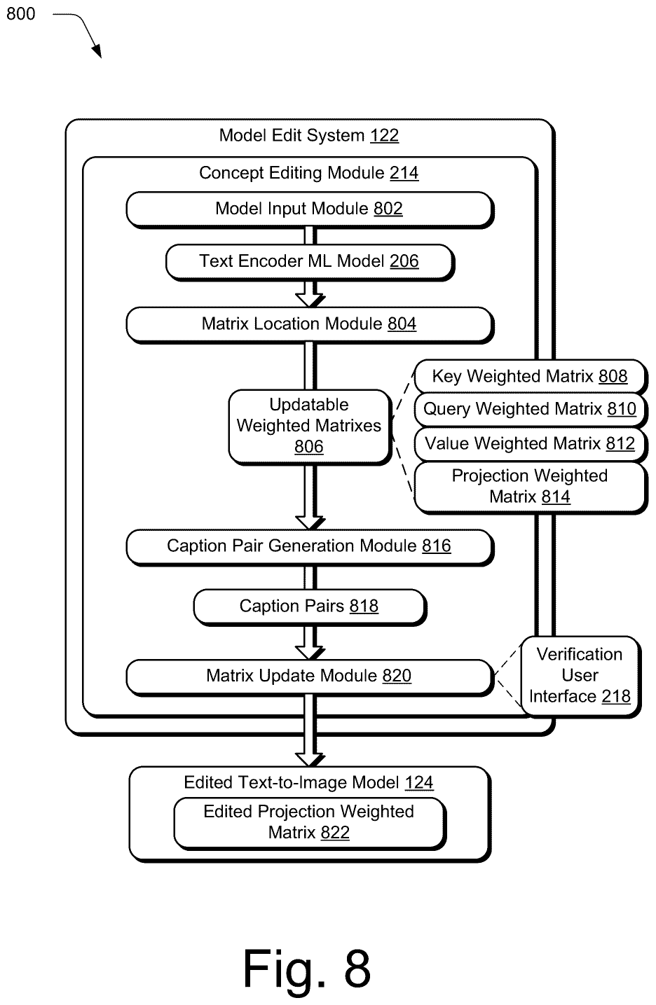

These techniques are performable over a number of iterations (i.e., timesteps) until a threshold similarity is achieved (e.g., based on the scoring techniques) to locate which nodes and/or layers of the uncorrupted ML model 604 when copied to the corrupted ML model 608 to form the restored ML model 614 cause expression of the visual attribute. Once this threshold amount of similarity is reached, a model location indication 626 is output by the causal mediation analysis module 208 to the concept editing module 214 as a basis to edit the text-to-image model 116, further discussion of which may be found in relation to FIG. 8.

In one or more implementations, classifier-free guidance is used by the causal mediation analysis module 208 during inference to regulate image-generation by incorporating scores from a conditional and unconditional diffusion model at each of the time-steps. In particular, at each time-step, classifier-free guidance is used in the following way:

$$ϵ\_θ ( ( z\_t ) \hat{} c , t , ) = ϵ\_θ ( z\_t , c , t ) + α ( ϵ\_θ ( z\_t , c , t ) - ϵ\_θ ( z\_t , t ) ) , ∀ t ∈ [ T , 0 ]$$

To perform causal tracing on the denoising U-Net model 204 “ϵ_{θ},” three types of models are employed as described above: (i) uncorrupted ML model 604 “ϵ_{θ},” where classifier-free guidance is used as default. (ii) corrupted ML model 608 “ϵ_{θ}^{corr}” where the word embedding of the subject (e.g., picnic basket of FIG. 3) of a given visual attribute (e.g., object) corresponding to a caption “c” is corrupted with Gaussian Noise. (iii) and a restored ML model 614 “ϵ_{θ}^{restored}” which is similar to “ϵ_{θ}^{corr}” except that one or more of its nodes and/or layers are restored from the uncorrupted ML model 604 at each time-step of the classifier-free guidance.

Given a list of layers “ [symbol] ” let “αᵢ∈ [symbol] ” denote the “i^{th}” layer whose importance is to be evaluated. Let “∈_{θ}[αᵢ], ϵ_{θ}^{corr}[αᵢ]” and “ϵ_{θ}^{restored} [αᵢ]” denote the activations of the “αᵢ” layer. To find a relative importance of an effect of “αᵢ” layer for a particular visual attribute embedded in a caption “c,” the following replacement operation is performed by the replacement module 616 on the corrupted ML model 608 “ϵ_{θ}^{corr}” to obtain the restored ML model 614 “ϵ_{θ}^{restored}”:

$${ϵ}_{θ}^{restored} [ {a}_{i} ] : {ϵ}_{θ}^{corr} [ {a}_{i} ] = {ϵ}_{θ} [ {a}_{i} ]$$

Next, by replacing the activations from the uncorrupted ML model 604 to the corrupted ML model 608 for the restored ML model 614 for the “αᵢ” layer “ϵ_{θ}^{restored} [αᵢ]” classifier-free guidance is performed to obtain the final latent code “z₀.”

$${ϵ}_{θ}^{restored} ( {z}_{t} , c , t ) = {ϵ}_{θ}^{restored} ( {z}_{t} , c , t ) + α ( {ϵ}_{θ}^{restored} ( {z}_{t} , c , t ) - {ϵ}_{θ}^{restored} ( {z}_{t} , t ) ) , \\ ∀ t ∈ [ T , 0 ]$$

The final latent code “z₀” is then passed through a decoder to obtain the candidate digital image 620 as “x₀.” In this way, the encoder-decoder knowledge tracking module 210 is usable by the causal mediation analysis module 208 to locate a portion of the symmetric encoder-decoder ML model 202 that influences generation of the visual attribute. Similar techniques are also usable by the text-encoder knowledge tracing module 212 for the text encoder ML model 206, further discussion of which is included in the following description and shown in a corresponding figure.

FIG. 7 depicts a system 700 in an example implementation showing operation of the text-encoder knowledge tracing module 212 by the causal mediation analysis module 208 in greater detail. In this example, the causal mediation analysis module 208 employs a text-encoder knowledge tracing module 212 to localize a portion of the text encoder ML model 206 associated with the visual attribute. To do so, the text-encoder knowledge tracing module 212 employees techniques similar to those described in relation to FIG. 6 for the symmetric encoder-decoder ML model 202.

The model input module 702 receives an uncorrupted machine learning model, depicted as an uncorrupted ML model 704. The uncorrupted ML model 704 in this example is configurable as a text encoder ML model 206 from the text-to-image model 116 that is unchanged. The uncorrupted ML model 704 is then passed to a corrupted model generation module 706 to generate a corrupted machine learning model (illustrated as corrupted ML model 708) from the uncorrupted ML model 704. To do so, the corrupted model generation module 706 employs a Gaussian noise generation module 710 to generate Gaussian noise by applying noise to activations of nodes of the uncorrupted ML model 604.

A restoration module 712 is then utilized in this example to generate a restored machine learning model (illustrated as restored ML model 714) from the corrupted ML model 708. As part of this, a replacement module 716 is utilized to replace activations at one or more nodes and/or one or more layers of the corrupted ML model 708 with activations from the uncorrupted ML model 704. The replacement module 716, for instance, selects a layer within the uncorrupted ML model 704 and passes activations from that layer as replacing activations at a corresponding layer of the corrupted ML model 708, thereby forming the restored ML model 714.

The restored ML model 714 is then passed to a candidate digital image generation module 718 to generate a candidate digital image 720. The candidate digital image generation module 718, for instance, utilizes a text input (e.g., the visual attribute input 216) corresponding to the visual attribute in question and from this generates the candidate digital image 720.

A knowledge detection module 722 is then utilized by the text-encoder knowledge tracing module 212 to compare the candidate digital image 720 with a digital image generated by the uncorrupted ML model 704, i.e., the text encoder ML model 206 in this example. The comparison is utilized to detect a similarity of the candidate digital image 720 with the digital image generated by the uncorrupted ML model 704, and therefore whether the replaced activations from the nodes and/or layers of the uncorrupted ML model 704 caused the change. The comparison module 724 is configurable to perform the comparison in a variety of ways, examples of which include scoring techniques to measure visual similarity such as Cosine similarity which is a use of a indirect estimation effect as part of a causality determination, perceptual similarity (e.g., a Dream-Sim-Score), and so forth.

These techniques are performable over a number of iterations until a threshold similarity is achieved, e.g., based on the scoring techniques, to locate which nodes and/or layers of the uncorrupted ML model 704 when copied to the corrupted ML model 708 to form the restored ML model 714 cause expression of the visual attribute. Once this threshold amount of similarity is reached, a model location indication 726 is output by the causal mediation analysis module 208 to the concept editing module 214 as a basis to edit the text-to-image model 116.

Similar to the example of FIG. 6, three states of the text encoder ML model 206 are described: (i) the uncorrupted ML model 704 as a text encoder ML model 206 denoted by “v_{γ}”, (ii) corrupted ML model 708 “v_{γ}^{corr}” where the word embedding of the subject in a given caption “c” is corrupted, and (iii) restored ML model 714 “v_{γ}^{restored}” which is similar to “v_{γ}^{corr}” except that a portion of activations from one or more nodes and/or layers are copied from uncorrupted ML model 704 “v_{γ}.” Similar to the discussion of the previous figure, the knowledge detection module 722 is tasked with finding a location associated with the visual tribute of the layer “α₂|∈ [symbol] ” where “ [symbol] ” includes each of the layers to probe in the text-encoder ML model 206:

$${v}_{γ}^{restored} [ {a}_{i} ] : {v}_{γ}^{corr} [ {a}_{i} ] = {v}_{γ} [ {a}_{i} ]$$

The restored ML model 714 as a restored text-encoder “v_{γ}^{restored}” are evaluated using classifier-free guidance to generate an image “x₀”:

$${ϵ}_{θ} ( {z}_{t} , {c}^{′} , t ) = {ϵ}_{θ} ( {z}_{t} , {c}^{′} , t ) + α ( {ϵ}_{θ} ( {z}_{t} , {c}^{′} , t ) - {ϵ}_{θ} ( {z}_{t} , t ) ) , ∀ t ∈ [ T , 0 ]$$

where “c′=v_{γ}^{restored} [α₁](c)” for a given caption “c.” Note that the same restored text-encoder is used across each of the time-steps of classifier-free guidance in this example, as the text encoder ML model 206 is disentangled from the time-steps, unlike the causal tracing by the encoder-decoder knowledge tracking module 210 of FIG. 6.

FIG. 8 depicts a system 800 in an example implementation showing operation of the concept editing module 214 of the model edit system 122 in greater detail in editing a text encoder ML model 206. As previously described, the model edit system 122 is configured to first understand how knowledge is implemented in the text-to-image model 116 and then use this information to utilize a technique to edit the text-to-image model 116. In an implementation example, it has been found that a single causal state, the first self-attention layer, is included in the text-to-image model 116. Accordingly, in this example a technique is described to update weight matrixes in the first self-attention layer in the text encoder ML model 206 independent of (e.g., without using) digital images.

The concept editing module 214 supports a variety of technical advantages. The concept editing module 214, for instance, is data-free, indicating that operation of the concept editing module 214 may be performed without use of training digital images in order to update model weights. The concept editing module 214 is also approximately a thousand times faster, in testing, than conventional techniques in order to generate the edited text-to-image model 124, e.g., in order to update or remove concepts in the text-to-image model 116. The model edit system 122 is configurable, in one or more instances, to consume less than a second to update or remove concepts from the given generative model.

In the illustrated example, the concept editing module 214 includes a model input module 802 that in the illustrated examples obtains a text encoder ML model 206 from the text-to-image model 116. A matrix location module 804 is then employed to obtain updatable weight matrixes 806 used by the text encoder ML model 206. Examples of the updatable weight matrixes 806 include a key weight matrix 808, a query weighted matrix 810, a value weighted matrix 812, and a projection weighted matrix 814.

A first self-attention layer of the text encoder ML model 206, for instance, includes four updatable weight matrices 806, in which “Wₖ, W_{q}, Wᵥ,” are a key weighted matrix 808, a query weight matrix 810, and a value weighted matrix 812 for key, query and value embeddings, respectively. An updatable weighted matrix of “Wₒᵤₜ” is a projection weighted matrix 814 before final layer output.

The concept editing module 214 is configured to update the projection weighted matrix 814 “Wₒᵤₜ” matrix. To do so, a caption pair generation module 816 generates caption pairs 818 “(k, v)” in which key “k” is an initial caption and value “v” is a caption, to which, “k” is to be mapped.

To remove the style of Van Gogh, for instance, the key “k” is “Style of Van Gogh” and the value “v” is set as a “Style of a generic water-color”. In order to update the projection weighted matrix 814, a matrix update module 820 is configured to update the projection weighted matrix 814 “Wₒᵤₜ,” to solve the following optimization problem:

$${min}_{{W}_{out}} {\sum }_{i = 1}^{N} {‖ {W}_{out} {k}_{i} - {v}_{i} ‖}_{2}^{2} + λ {‖ {W}_{out} - {W}_{out}^{′} ‖}_{2}^{2} ,$$

where “λ” is a regularizer used to prevent edited weights from deviating significantly from the original pre-trained weights “W′ₒᵤₜ, N, N” denotes a total number of caption pairs containing the last subject token embeddings of the key and value. One shown in the below expression, a closed-form solution is supported due to absence of any non-linearities. In particular, an edited projection weighted matrix 822 used to generate the edited text-to-image model 124 is configurable as an optimal projection weighted matrix “Wₒᵤₜ” may be expressed as:

$${W}_{out} = ( λ {W}_{out}^{′} + {\sum }_{i = 1}^{N} {v}_{i} {k}_{i}^{T} ) {( λ I + {\sum }_{i = 1}^{N} {k}_{i} {k}_{i}^{T} )}^{- 1}$$

By editing the projection weighted matrix 814 “Wₒᵤₜ” corresponding to a first self-attn layer in the text-encoder, as opposed to the whole text encoder ML model 206, the updated weights can be therefore saved to a storage device as it consumes less than 0.06% of the total parameters present in the underlying text-to-image model 116.

Once edited, the matrix update module 820 may also support output of a verification user interface to verify efficacy of the edit. FIG. 4 depicts an example implementation 400 of the verification user interface 218. The user interface 218 displays a first digital image 402 generated by the 116 for a text input, e.g., the visual attribute input 216. The verification user interface 218 also displays a second digital image 404 generated by the edited text-to-image model 124.

Continuing with the example of FIG. 3, the visual attribute input 216 includes the text of a “picnic table.” The first digital image 402 also includes an object 406 corresponding to this text, the picnic table. The second digital image 404 has the object 406 removed. Other examples are also contemplated, e.g., to change the picnic table into object, style of table, and so forth. Thus, the verification user interface 218 supports an ability to both view “how well” the edit to the edited text-to-image model 124 is performed.

A first option is included to “approve” 408 the edit to the model, which causes processing by the model edit system 122 to cease. However, if the edited text-to-image model 124 did not perform as intended, a second option is also provided to “try again” 410 to cause the model edit system 122 to repeat the above localization and edit operations, e.g., which may include functionality to provide additional textual inputs (e.g., return to the user interface 302 of FIG. 3) to further clarify the visual attribute input 216.

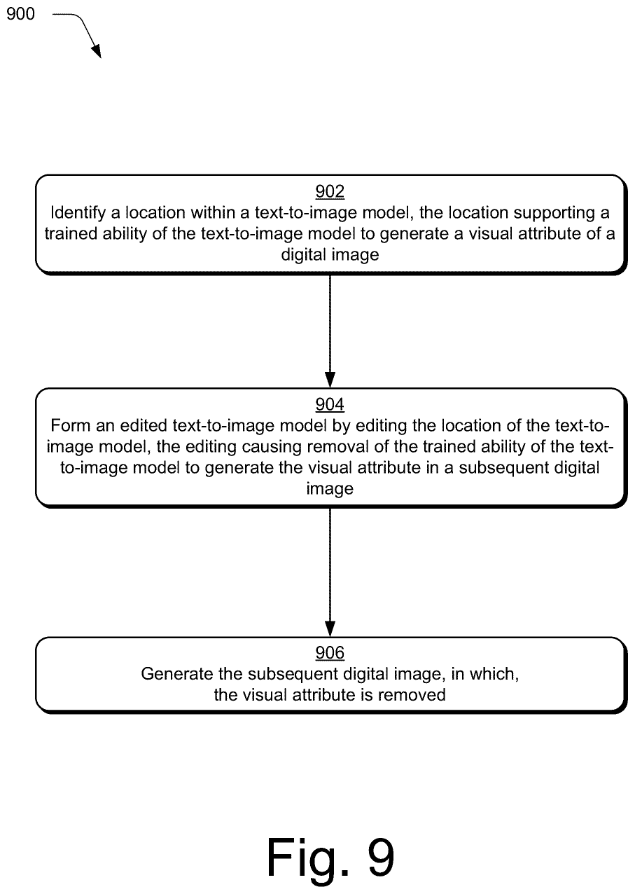

FIG. 9 is a flow diagram depicting an algorithm 900 as a step-by-step procedure in an example implementation of operations performable for accomplishing a result of forming an edited text-to-image model based on a location identified as corresponding to a visual attribute in the text-to-image model. To begin in this example, a causal mediation analysis module 208 of a model edit system 122 identifies a location within a text-to-image model 116. The location is configured to generate a visual attribute of a digital image (block 902).

An edited text-to-image model 124 is formed by a concept editing module 214 of the model edit system 122 by editing the location of the text-to-image model 116. The edit causes removal of a trained ability of the text-to-image model to generate the visual attributes in a subsequent digital image (block 904), an example of which is shown in FIG. 4. The subsequent digital image is then generated by the editing text-to-image model, in which, the visual attribute is removed (block 906).

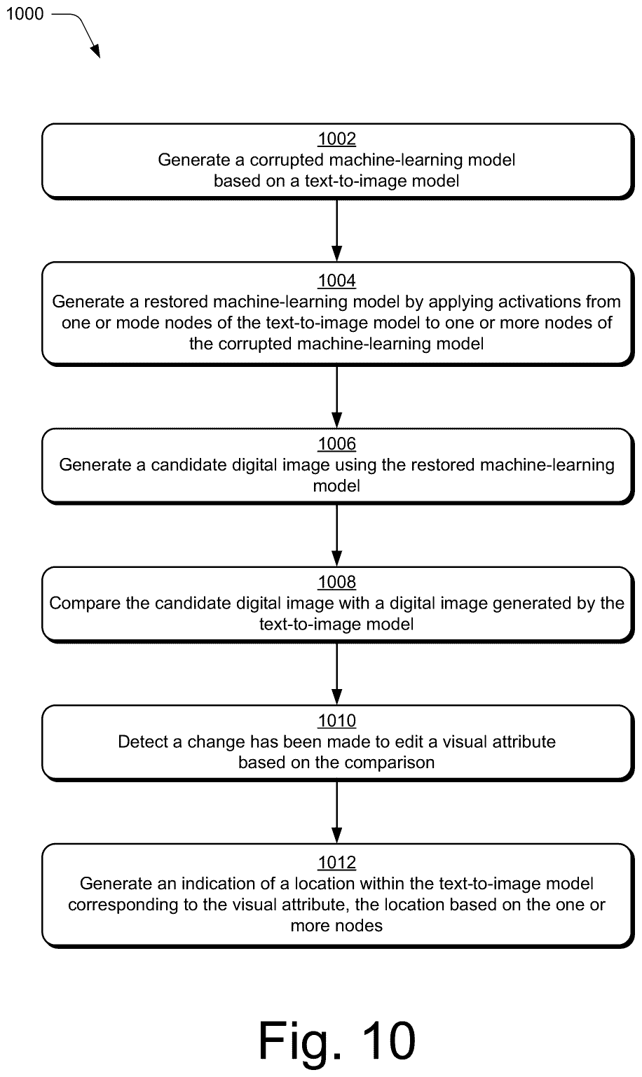

FIG. 10 is a flow diagram depicting an algorithm 1000 as a step-by-step procedure in an example implementation of operations performable for accomplishing a result of forming an edited text-to-image model based on an uncorrupted machine learning model, a corrupted machine learning model, and a restored machine learning model. A corrupted machine-learning model 608, 708 is generated by a corrupted model generation module 606, 706 based on a text-to-image model 116 (block 1002), e.g., for a symmetric encoder-decoder ML model 202 and/or a text encoder ML model 206 using Gaussian noise.

A restoration module 612, 712 is implemented to generate a restored machine-learning model 614, 714. The restoration module 612, 712 does so by applying one or more activations from one or more nodes of the text-to-image model 116 to the corrupted machine-learning model 608, 708 (block 1004).

A candidate digital image generation module is then implemented to generate candidate digital images 620, 720 using the restored machine-learning model 614, 714 (block 1006). The candidate digital images 620, 720 are compared by a knowledge detection module 622, 722 with a corresponding digital image generated by the text-to-image model 116 (block 1008), e.g., for a same text input.

A change is detected in this example as an edit to a visual attribute based on the comparison (block 1010). In response, a model location indication 626 is generated indication a location within the text-to-image model 116 corresponding to the visual attribute. The location is based on the one or more nodes (block 1012), e.g., the one or more nodes or layers from which the activations are copied from the text-to-image model 116.

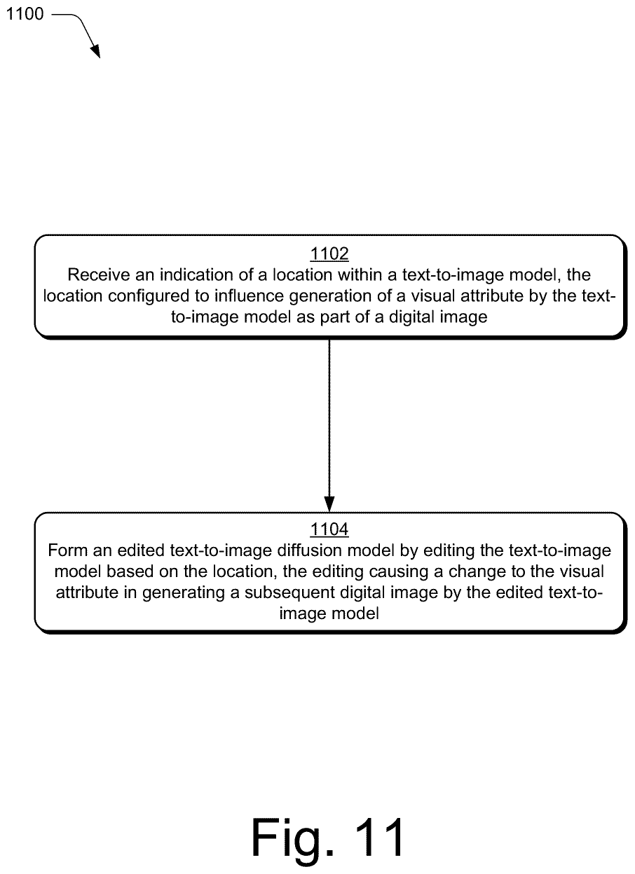

FIG. 11 is a flow diagram depicting an algorithm 1100 as a step-by-step procedure in an example implementation of operations performable for accomplishing a result of forming an edited text-to-image model by editing a text to image mode based on a location configured to influence generation of a visual attribute. In this example, an indication is received (e.g., a model location indication 626, 726) of a location within a text-to-image model 116. The location is configured to influence generation of a visual attribute by the text-to-image model 116 as part of a digital image (block 1102), e.g., to form a picnic table as shown in FIG. 3.

An edited text-to-image model 124 is formed by the model edit system 122 by editing the text-to-image model 116 based on the location. The edit causes a change to the visual attribute in generating a subsequent digital image by the edited text-to-image model (block 1104), e.g., to remove an ability to generate the picnic table, change the picnic table into another style of table, and so on. A variety of other examples are also contemplated.

### Example System and Device

FIG. 12 illustrates an example system generally at 1200 that includes an example computing device 1202 that is representative of one or more computing systems and/or devices that implement the various techniques described herein. This is illustrated through inclusion of the model edit system 122. The computing device 1202 is configurable, for example, as a server of a service provider, a device associated with a client (e.g., a client device), an on-chip system, and/or any other suitable computing device or computing system.

The example computing device 1202 as illustrated includes a processing device 1204, one or more computer-readable media 1206, and one or more I/O interface 1208 that are communicatively coupled, one to another. Although not shown, the computing device 1202 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1204 is representative of functionality to perform one or more operations using hardware. Accordingly, the processing device 1204 is illustrated as including hardware element 1210 that is configurable as processors, functional blocks, and so forth. This includes implementation in hardware as an application specific integrated circuit or other logic device formed using one or more semiconductors. The hardware elements 1210 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1206 is illustrated as including memory/storage 1212 that stores instructions that are executable to cause the processing device 1204 to perform operations. The memory/storage 1212 represents memory/storage capacity associated with one or more computer-readable media. The memory/storage 1212 includes volatile media (such as random access memory (RAM)) and/or nonvolatile media (such as read only memory (ROM), Flash memory, optical disks, magnetic disks, and so forth). The memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1202. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1210. The computing device 1202 is configured to implement particular instructions and/or functions corresponding to the software and/or hardware modules. Accordingly, implementation of a module that is executable by the computing device 1202 as software is achieved at least partially in hardware, e.g., through use of computer-readable storage media and/or hardware elements 1210 of the processing device 1204. The instructions and/or functions are executable/operable by one or more articles of manufacture (for example, one or more computing devices 1202 and/or processing devices 1204) to implement techniques, modules, and examples described herein.

The techniques described herein are supported by various configurations of the computing device 1202 and are not limited to the specific examples of the techniques described herein. This functionality is also implementable all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 abstracts resources and functions to connect the computing device 1202 with other computing devices. The platform 1216 also serves to abstract scaling of resources to provide a corresponding level of scale to encountered demand for the resources 1218 that are implemented via the platform 1216. Accordingly, in an interconnected device embodiment, implementation of functionality described herein is distributable throughout the system 1200. For example, the functionality is implementable in part on the computing device 1202 as well as via the platform 1216 that abstracts the functionality of the cloud 1214.

In implementations, the platform 1216 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
identifying, by a processing device, a location within a text-to-image model, the location supporting a trained ability of the text-to-image model to generate a visual attribute in a digital image;
forming, by the processing device, an edited text-to-image model by editing the location of the text-to-image model, the editing causing removal of the trained ability of the text-to-image model to generate the visual attribute in a subsequent digital image; and
generating, by the processing device, the subsequent digital image by the edited text-to-image model, in which, the visual attribute is removed.

2. The method as described in claim 1, wherein the identifying is performed using causal mediation analysis by analyzing causal inference through change in a response variable of the visual attribute following an intervention on intermediate variables of interest of the text-to-image model.

3. The method as described in claim 1, wherein the location is identified as corresponding to one or more nodes included in at least one layer of the text-to-image model and the editing the location includes editing one or more activations associated with the one or more nodes included in the at least one layer.

4. The method as described in claim 1, wherein the identifying includes:
generating a corrupted machine-learning model based on the text-to-image model;
generating a restored machine-learning model by applying activations from nodes includes in at least one layer of the text-to-image model to nodes of the corrupted machine-learning model;
detecting a change has been made to edit the visual attribute by comparing a candidate digital image generated by the restored machine-learning model to a digital image generated by the text-to-image model; and
generating a model location indication indicating the location within the text-to-image model as corresponding to the node activations from the at least one layer.

5. The method as described in claim 4, wherein the corrupted machine-learning model is generated by applying Gaussian noise to the text-to-image model.

6. The method as described in claim 5, wherein the Gaussian noise is applied to:
a symmetric encoder-decoder machine learning model of the text-to-image model; or
a text encoder machine learning model of the text-to-image model.

7. The method as described in claim 1, wherein the editing the location within the text-to-image model includes editing at least one weight matrix associated with a layer of the text-to-image model.

8. The method as described in claim 7, wherein the weight matrix is a projection matrix associated with a self-attention layer of a text-encoder machine-learning model of the text-to-image model.

9. The method as described in claim 8, wherein the self-attention layer is a first layer of the text-encoder machine-learning model.

10. The method as described in claim 1, further comprising receiving a visual attribute input via a user interface that identifies the visual attribute and wherein the identifying is performed responsive to the receiving.

11. The method as described in claim 10, wherein the visual attribute input indicates an object, style, color, viewpoint, action, or concept.

12. The method as described in claim 1, wherein the text-to-image model is configured to generate the digital image as having the visual attribute based on a text input and the edited text-to-image model is configured to generate the subsequent digital image as having a change to the visual attribute based on the text input.

13. The method as described in claim 1, wherein the location is configured to influence generation of the visual attribute by the text-to-image model and the forming is based on the location and causes causing a change to the visual attribute in generating the subsequent digital image by the edited text-to-image model.

14. A system comprising:
a corrupted model generation module implemented by a processing device to generate a corrupted machine-learning model based on a text-to-image model;
a restoration module implemented by the processing device to generate a restored machine-learning model by applying one or more activations from one or more nodes of the text-to-image model to the corrupted machine-learning model;
a candidate digital image generation module implemented by the processing device to generate candidate digital image using the restored machine-learning model; and
a knowledge detection module implemented by the processing device to indicate a location within the text-to-image model corresponding to a visual attribute based on the candidate digital image.

15. The system as described in claim 14, wherein the corrupted model generation module is configured to generate the corrupted machine-learning model by applying Gaussian noise to a symmetric encoder-decoder machine-learning model of the text-to-image model or a text encoder machine-learning model of the text-to-image model.

16. The system as described in claim 14, further comprising a concept editing module implemented by the processing device to form an edited text-to-image model by editing the location within the text-to-image model, the editing causing a change to the visual attribute in generating a subsequent digital image by the edited text-to-image model.

17. The system as described in claim 16, wherein the editing the location within the text-to-image model includes editing at least one weight matrix associated with a layer of the text-to-image model.

18. The system as described in claim 17, wherein the weight matrix is a projection matrix associated with a self-attention layer of a text-encoder machine-learning model of the text-to-image model.

19. One or more computer-readable media storing instructions that, responsive to execution by a processing device, causes the processing device to perform operations including:
receiving an indication of a location within a text-to-image model, the location configured to influence generation of a visual attribute by the text-to-image model as part of a digital image; and
forming an edited text-to-image model by editing the text-to-image model based on the location, the editing causing a change to the visual attribute in generating a subsequent digital image by the edited text-to-image model.

20. The one or more computer-readable media as described in claim 19, wherein the editing the location within the text-to-image model includes editing at least one weight matrix associated with a layer of the text-to-image model.
